(19) United States
(12) Patent Application Publication
(10) Pub. No.: US 2024/0293946 A1
(43) Pub. Date: Sep. 5, 2024

(54) SHAVING RAZOR

(71) Applicant: The Gillette Company LLC, Boston, MA (US)

(72) Inventor: Aline Andrea Vargas, Cambridge, MA (US)

(21) Appl. No.: 18/116,049

(22) Filed: Mar. 1, 2023

(51) Int. Cl. B26B 21/44; B26B 21/22; B26B 21/40; B26B 21/52

(52) U.S. Cl. CPC B26B 21/446; B26B 21/225; B26B 21/4025; B26B 21/52

(57) ABSTRACT

A shaving razor system with a handle having a first end defining an opening and a second end. A shaving razor cartridge is mounted to the second end of the handle. A plurality of pre-moistened substrate sheets are positioned within the opening. A cap is mounted to the first end of the handle. The handle defines a slot configured to dispense the pre-moistened substrate sheets.

### FIELD OF THE INVENTION

The present invention relates to shaving razors and more particularly to, shaving razors that dispense personal care wipes.

### BACKGROUND OF THE INVENTION

Skin care can be of particular importance in improving or enhancing the appearance of men and women. Various products and methods can be used to care for skin. For example, exfoliant scrubs, cleansers, and lotions are sometimes used to maintain healthy-looking skin. Exfoliant scrubs can be used to remove dead skin cells from the surface of the skin, which can give the skin an improved tone. Soaps and other cleansers can be used to remove dirt and excess oil from the skin, which can help prevent clogging of pores. Consequently, acne and other types of skin blemishes can be prevented in some cases. Lotions and various other topical ointments can also be used to deliver nutrients and/or moisturizers to the skin in an effort to improve the appearance and/or the health of the skin. Other types of cosmetic products (e.g., creams and lotions) or drug actives are sometimes used in an attempt to eliminate wrinkling and other signs of aging.

It is generally known that the process of shaving the skin may provide certain skin benefits such as exfoliation and hydration. In general, shaving razors of the wet shave type include a cartridge or blade unit with at least one blade with a cutting edge which is moved across the surface of the skin being shaved by means of a handle to which the cartridge is attached; however, razor assemblies may also include electric foil type shavers. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor). The connection of the cartridge to the handle provides a pivotal mounting of the cartridge with respect to the handle so that the cartridge angle adjusts to follow the contours of the surface being shaved. In such systems, the cartridge can be biased toward a rest position by the action of a spring-biased plunger (a cam follower) carried on the handle against a cam surface on the cartridge housing.

The shaving process can include several steps. For example, the skin may be first cleansed from dirt and bacteria, followed by the application of a shaving aid material (e.g., shaving cream) to the surface. The skin is then shaved to remove hair followed by an additional step of removing excess shaving cream and cut hair from the skin. Some users will apply a moisturizer as final step. Most consumers find shaving to be a chore and inconvenient because of the need for multiple steps and multiple shaving products, e.g., a wet shaving razor and a skin preparation product, as well as the undesirable necessity for multiple application steps during the wet shaving process. Furthermore, this process can be messy and requires the consumer rinse their hands after applying the shave gel. This multi-step process also results in an overall extended shaving experience which most consumers do not prefer given typical morning hygiene routines. It may, however, be desirable sometimes to apply liquids of other kinds to the skin before, during, or after shaving. It has been found that especially in the case of males who shave facial hair, it is important to provide a shave preparation of some sort prior to shaving to adequately hydrate the coarser facial hairs to allow for an easier and closer shave.

In the past, there have been a number of wet shaving product configurations that include a system for conveying a shaving preparation during shaving, e.g. a lubricating liquid, from a reservoir incorporated in the razor structure or even an aerosol can that acts as a razor handle, to a dispensing location near the head of the razor. Many of these types of razors that are capable of conveying a liquid to the skin surface are unfortunately plagued by a number of problems. For instance, razors that require pump mechanisms add cost and complexity, which can drive up costs for the consumer. In addition, replaceable bottles of shaving lotion or moisturizer are typically made from plastic, which are not very sustainable. Accordingly, it is difficult to incorporate various design features into a shaving razor in a simple, sustainable and cost effective manner.

### SUMMARY OF THE INVENTION

In one aspect, the invention features, in general a shaving razor system including a handle having a first end defining an opening and a second end. A shaving razor cartridge is mounted to the second end of the handle. A plurality of pre-moistened substrate sheets are positioned within the opening. A cap is mounted to the first end of the handle. The handle defines a slot configured to dispense the pre-moistened substrate sheets.

In another aspect, the invention features, in general a shaving razor kit having a plurality of pre-moistened substrate sheets positioned within a sealed container. A handle defining an opening at a first end configured to receive the pre-moistened substrate sheets. The handle defines a slot configured to dispense the pre-moistened substrate sheets. A shaving razor cartridge configured to mount to a second end of the handle is provided. A cap is provided that is configured to mount to the first end of the handle.

In another aspect, the invention features, in general a shaving razor system with a handle having a first end defining an opening and a second end. A shaving razor cartridge is mounted to the second end of the handle. A plurality of pre-moistened substrate sheets are positioned within the opening. A cap is mounted to the first end of the handle. The cap defines a slot configured to dispense the pre-moistened substrate sheets.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is a perspective view of a shaving razor.

FIG. 2 is an assembly view of the shaving razor of FIG. 1.

FIG. 3 is a perspective view of a shaving razor kit.

FIG. 4 is a perspective assembly view of another possible embodiment of a shaving razor.

### DETAILED DESCRIPTION OF THE INVENTION

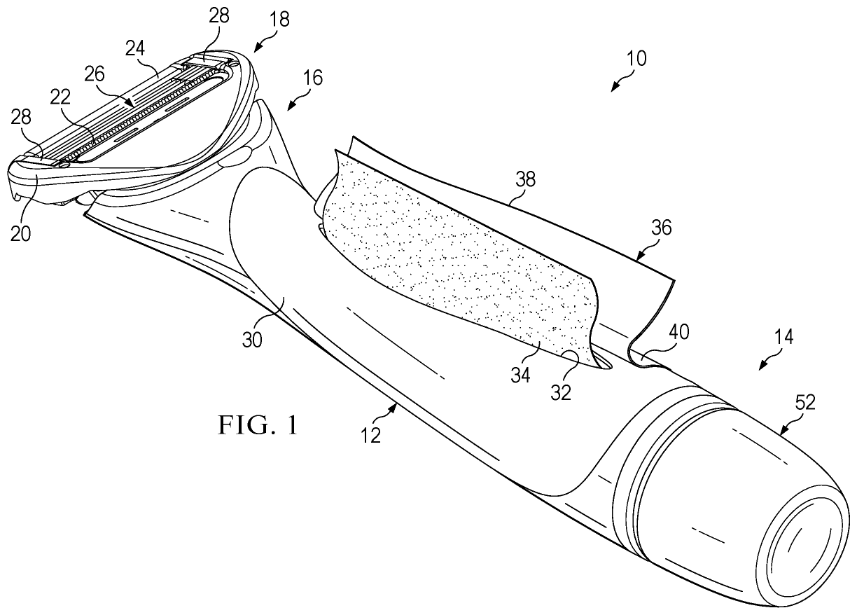

Referring to FIG. 1, a perspective view of a shaving razor system 10, is shown. The shaving razor system 10 may include handle 12 having a first end 14 and a second end 16. A shaving razor cartridge 18 may be mounted to the second end 16 of the handle 12. The shaving razor cartridge 18 may be removable or permanently mounted to the handle 12. For example, the shaving razor cartridge 18 may be detachably mounted to the handle 12 to enable the shaving razor cartridge 18 to be replaced by a fresh shaving razor cartridge 18 when blade sharpness has diminished to an unsatisfactory level. Alternatively, the shaving razor cartridge 18 may be attached permanently to the handle 12 with the intention that the entire shaving razor system 10 be discarded when the blade or blades have become dulled. The shaving razor cartridge 18 may include a housing 20. The housing 20 may be injection molded from a polymeric material. The housing 20 may be molded from polymers such as high impact polystyrene (HIPS), but other semi-rigid polymers such as polypropylene (PP), nylon, acrylonitrile butadiene styrene (ABS), polyphenylene ether, polystyrene, and combinations thereof may also be used.

A guard 22 may be positioned toward a front of the housing 20 and a cap 24 may be positioned at a rear portion of the housing 20. The guard 22 may be a unitary elongated member that can be formed of a rigid plastic (e.g., the same material as the housing 22). For example, the guard 22 may be a solid or segmented bar that extends generally parallel to the cap 24 to help support the skin during a shaving stroke. The guard 22 and the cap 24 may define a shaving plane that is tangent to the guard 22 and the cap 24. One or more blade members 26 each having a respective cutting edge may be mounted to the housing 20 between the cap 24 and the guard 22 (i.e., in front of the cap 24 behind the guard 22). Although five blade members 26 are shown, the shaving razor cartridge 18 may have more or fewer blade members 26 depending on the desired performance and cost of the shaving razor cartridge 18. The blade members 26 may be secured to the housing 18 with one or more blade retention members 28, such as clips.

As will be described in greater detail below, the handle 12 may include a body 30 between the first end 14 and the second end 16 that defines a slot 32 configured to dispense one or more pre-moistened substrate sheets 34. The pre-moistened substrate sheets 34 may comprise one or more ingredients, such as water, purified water, alcohol, aloe vera, vitamins, essential oils, fragrances, an aqueous lotion or moisturizer or any combinations thereof to facilitate the moistening of the skin and hair before and/or after shaving. In certain embodiments, the pre-moistened substrate sheets 34 may be wetted with a aqueous solution of water soluble or water dispersible ingredients. The pre-moistened substrate sheets 34 may comprise wood pulp fiber, cellulosic fibers and combinations thereof for low cost and biodegradability. For example, paper, air-laid and carded non-woven webs may be used. However, spun-bonded and spun-lace webs may also suitable. For applications where cost and/or biodegradability are not important, alveolar polymeric films, foam and other porous sheets may be employed. Techniques for moistening the wipes are generally in the art and need not be elaborated here.

Although, the slot 32 is shown positioned on a body 30 of the handle 12, it is understood the slot 32 may be positioned on other areas of the handle 12, such as at the first end 14 (e.g., to dispense the pre-moistened substrate sheets 34 out the bottom of the handle 12). A removable lid 36 may be attached to the handle 12 to cover the slot 32 and help prevent the pre-moistened substrate sheets 34 from drying out. The a removable lid 36 may include a pressure sensitive label. For example, the removable lid 36 may have a first end 38 comprising a first adhesive that facilitates easy attachment and removal of the first end 38 of the removable lid 36 to the handle 12 (e.g., the body 30). A second end 40 of the removable lid 36 may comprise a second adhesive that has a stronger bond than the first adhesive. Accordingly, the bond at the second end 40 of the removable lid 36 may create a more permanent attachment to the body 30 of the handle 12. Alternatively, the removable lid 36 may include rigid structures having features such as snap fits, magnets, hook with loop type fasteners, or zippers that allow the removable lid 36 be temporarily secured to the handle 12 and cover the slot 32 to help keep the pre-moistened substrate sheets 34 from drying out.

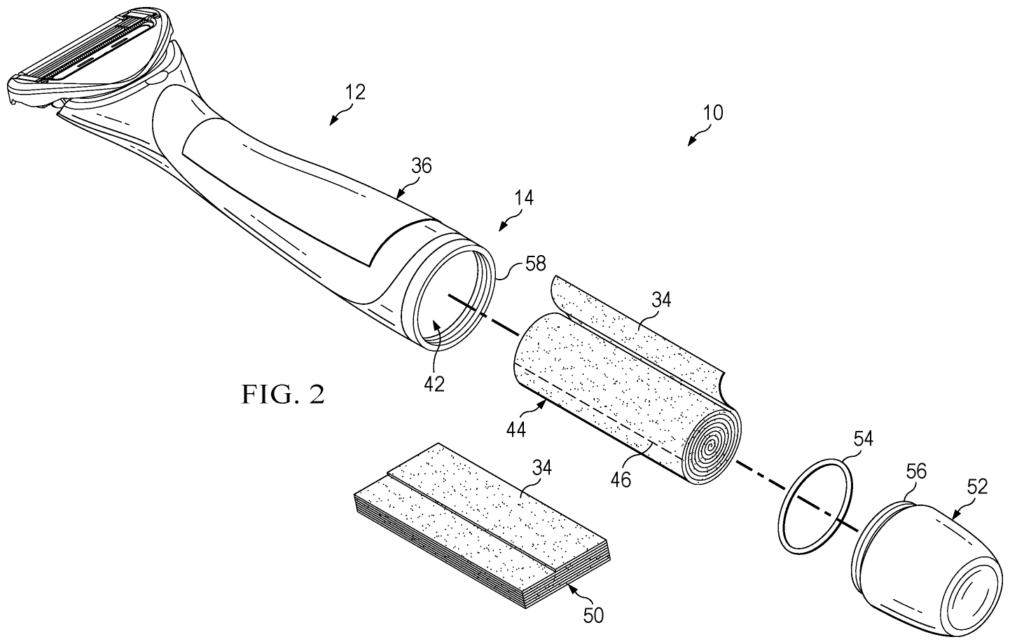

Referring to FIG. 2, an assembly view of the shaving razor system 10 is shown. The first end 14 of the handle 12 may define an opening 42 configured to receive the pre-moistened substrate sheets 34. The opening 42 may have a cross sectional area of about 110 mm2 to about 1200 mm2 and a length of about of about 75 mm to about 130 mm, which may be determined based on the desired number and size of the pre-moistened substrate sheets 34. Depending on the size and configuration of the handle 12, the pre-moistened substrate sheets 34 may be provided as a roll 44 having one or more perforations 46 separating the pre-moistened substrate sheets 34. For example, the handle 12 may have a generally round cross section defining the opening 42 that is also generally cylindrical in shape to receive the roll 44. The opening 42 may facilitate loading and holding of the roll 44 of the pre-moistened substrate sheets 34. Alternatively, the pre-moistened substrate sheets 34 may be provided in a stacked configuration 50. The handle 12 may incorporate a more rectangular shape to better receive the stacked configuration 50 of the pre-moistened substrate sheets 34. The number of pre-moistened substrate sheets 34 in the roll 44 or the stack stacked configuration 50 may be sufficient for about one month of shaves, with the understanding that a consumer may use multiple pre-moistened substrate sheets 34 for each shave. If a consumer is shaving other parts of their body in addition to their face, such as their legs, they may end up using more pre-moistened substrate sheets 34. For example, the number of pre-moistened substrate sheets 34 in the roll 44 or the stack stacked configuration 50 may be about 10 to about 100 and more preferably about 30 to about 50.

The pre-moistened substrate sheets 34 may be generally rectangular or square in shape with a width of about 30 mm to about 90 mm, and preferably about 50 mm to about 70 mm. The pre-moistened substrate sheets 34 may have a length of about 50 mm to about 110 mm, and preferably about 70 mm to about 80 mm. The size and thickness of the pre-moistened substrate sheets 34 may allow or a sufficient number of the pre-moistened substrate sheets 34 to be positioned within the handle 12, without negatively impacting the ergonomics of the handle 12. The thickness of the pre-moistened substrate sheets 34 may also impact the number of pre-moistened substrate sheets 34 that may fit within the handle. In certain embodiments, the pre-moistened substrate sheets 34 may have a thickness of about 0.25 mm to about 2.0 mm and preferably about 0.5 mm to about 0.75 mm.

A cap 52 may be mounted to the first end 14 of the handle 12 to retain the pre-moistened substrate sheets 34 within the opening 42. However, it is understood the cap 52 may be hollow and retain a portion of the pre-moistened substrate sheets 34. In certain embodiments, a flexible seal 54 (e.g., an O-ring) may be positioned between the first end 14 of the handle 12 and the cap 52. The cap 52 may have threads 56 that engage corresponding threads 58 on the first end 14 of the handle 12. Although threads 56 and 58 are illustrated as securing the cap 52 to the handle 12, other attachment mechanisms known to those skilled in the art may be used, such as press fit and snap fit designs.

As shown in FIG. 2, the slot 32 of FIG. 1 may be covered by the removable lid 36. The shaving razor system 10 may be packaged in this configuration and the consumer may peel the removable lid back to reveal the slot 32 and expose the pre-moistened substrate sheets 34. The consumer may wet their face to hydrate and lubricate their skin and hair with one or more of the pre-moistened substrate sheets 34 prior to shaving with the shaving razor cartridge 18. The consumer may also use the pre-moistened substrate sheets 34 after they have completed shaving to remove any shaving debris from their skin. Accordingly, the consumer may not need to use running water to shave. The pre-moistened substrate sheets 34 may also be compostable or biodegradable for improved sustainability. After the pre-moistened substrate sheets 34 are depleted, the consumer may remove the cap 52 and insert more of the pre-moistened substrate sheets 34.

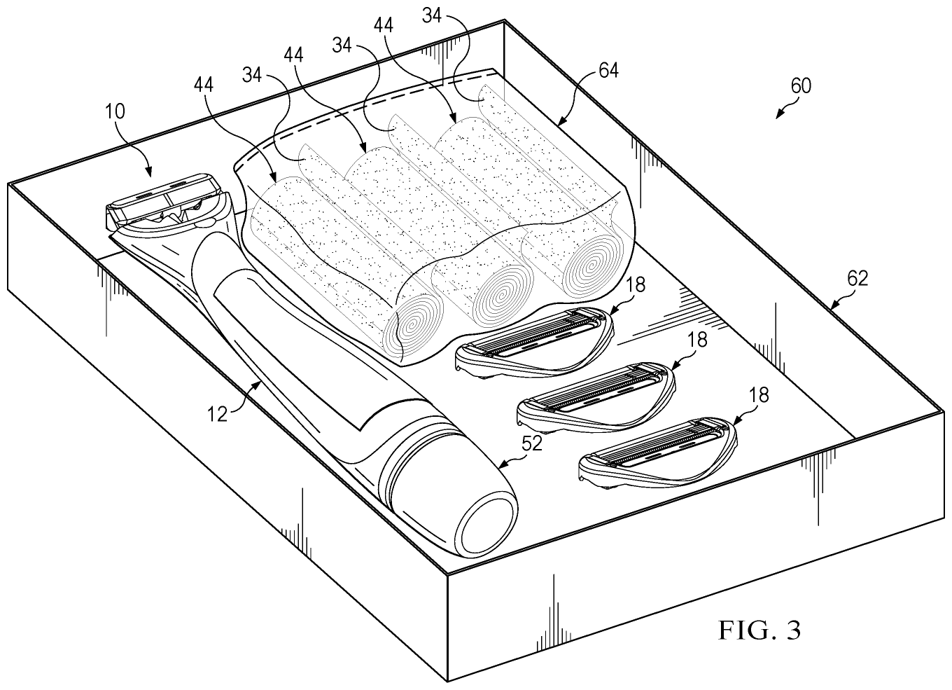

Referring to FIG. 3, a perspective view of a shaving razor kit 60 is illustrated. The shaving razor kit 60 may include a box 62 containing one or more of the rolls 44 of the pre-moistened substrate sheets 34. However, it is understood the pre-moistened substrate sheets 34 may be provided in the stacked configuration 50 (FIG. 3), as previously described. The kit 60 may also include the shaving razor system 10 positioned within the box 62. The shaving razor system 10 may be provided with one or more of shaving razor cartridges 18. The shaving razor cartridges 18 may be provided attached and/or detached from the handle 12. Additional shaving razor cartridges 18 may be provided in the shaving razor kit 60. Although, three shaving razor cartridges 18 are illustrated, it is understood more or less shaving razor cartridges 18 may be provided depending on the desired cost of the shaving razor kit 60. The cap 52 may be mounted to the handle 12 or provided separately to show where to insert the pre-moistened substrate sheets 34. One or more of the rolls 44 of the pre-moistened substrate sheets 34 may be positioned within a sealed container 64, such as a plastic bag to prevent them from drying out.

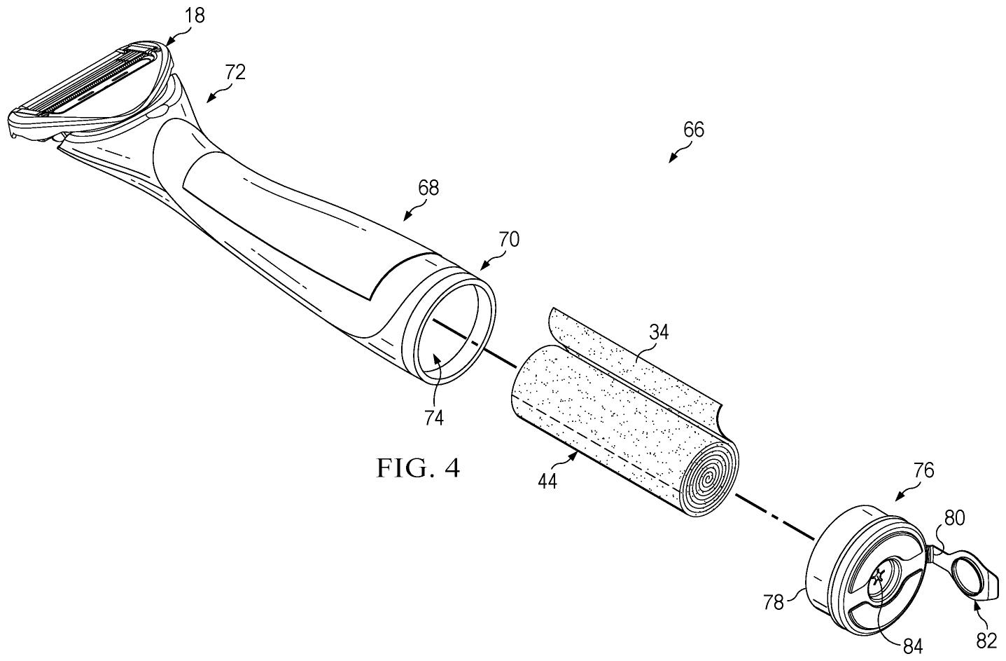

Referring to FIG. 4, an assembly view of an alternative embodiment of a shaving razor system 66 is shown. The shaving razor system 66 may include handle 68 having a first end 70 and a second end 72. The shaving razor cartridge 18 may be mounted to the second end 72 of the handle 68. The shaving razor cartridge 18 may be removable or permanently mounted to the handle 68. The first end 70 of the handle 68 may define an opening 74 configured to receive the pre-moistened substrate sheets 34 (e.g., the rolls 44). The opening 74 may have a cross sectional area of about 110 mm² to about 1200 mm² and a length of about of about 75 mm to about 130 mm, which may be determined based on the number and size of the pre-moistened substrate sheets 34. The opening 74 may facilitate loading and holding of the roll 44 of the pre-moistened substrate sheets 34.

A cap 76 may be mounted to the first end 70 of the handle 68 to retain the pre-moistened substrate sheets 34 within the opening 74. The cap 76 may include a body 78 having a hinge 80 connecting a lid 82 to the body 78. The body 76 may define a slot 84 to dispense the pre-moistened substrate sheets 34. The cap 76 may be press fit or snap fit to the first end 70 of the handle 68 to allow easy replacement of the pre-moistened substrate sheets 34.

The dimensions and values disclosed herein are not to be understood as being strictly limited to the exact numerical values recited. Furthermore, dimensions should not be held to an impossibly high standard of metaphysical identity that does not allow for discrepancies due to typical manufacturing tolerances. Therefore, the term “about” should be interpreted as being within typical manufacturing tolerances.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor system comprising:
a handle having a first end defining an opening and a second end;
a shaving razor cartridge mounted to the second end of the handle;
a plurality of pre-moistened substrate sheets positioned within the opening; and
a cap mounted to the first end of the handle, wherein the handle defines a slot configured to dispense the pre-moistened substrate sheets.

2. The shaving razor of claim 1 further comprising a removable lid mounted over the slot.

3. The shaving razor of claim 2 wherein the removable lid comprises a pressure sensitive label.

4. The shaving razor of claim 1 wherein the cap is removable.

5. The shaving razor of claim 4 wherein the cap comprises a threaded surface that engages a corresponding threaded surface on the first end of the handle.

6. The shaving razor of claim 4 further comprising an O-ring positioned between the cap and the handle.

7. The shaving razor of claim 1 wherein the cap is fixed to the first end of the handle.

8. The shaving razor of claim 1 wherein the opening has a length of about 75 mm to about 130 mm.

9. The shaving razor of claim 8 wherein the opening has a cross sectional area of about 110 mm² to about 1200 mm².

10. The shaving razor of claim 1 wherein the plurality of pre-moistened substrate sheets comprise a slit line between adjacent pre-moistened substrate sheets.

11. The shaving razor of claim 1 wherein the pre-moistened substrate sheets comprise at least one of water, purified water, alcohol, aloe vera, vitamins, essential oils, fragrances, an aqueous lotion, a moisturizer and any combinations thereof.

12. The shaving razor of claim 1 wherein the plurality of pre-moistened substrate sheets comprises a roll.

16. A shaving razor kit comprising:
a plurality of pre-moistened substrate sheets positioned within a sealed container;
a handle defining an opening at a first end of the handle that is configured to receive the plurality of pre-moistened substrate sheets, the handle defines a slot configured to dispense the pre-moistened substrate sheets;
a shaving razor cartridge configured to mount to a second end of the handle; and
a cap configured to mount to the first end of the handle.

17. A shaving razor kit of claim 16 wherein the sealed container comprises a plastic bag.

18. A shaving razor system comprising:
a handle having a first end defining an opening and a second end;
a shaving razor cartridge mounted to the second end of the handle;
a plurality of pre-moistened substrate sheets positioned within the opening; and
a cap mounted to the first end of the handle, wherein the cap defines a slot configured to dispense the pre-moistened substrate sheets.

19. The shaving razor of claim 1 wherein the plurality of pre-moistened substrate sheets comprises a roll.

20. The shaving razor of claim 18 wherein the opening has a length of about 75 mm to about 130 mm and a cross sectional area of about 110 mm² to about 1200 mm².
